(19) United States
(12) Patent Application Publication
(10) Pub. No.: US 2007/0283061 A1
(43) Pub. Date: Dec. 6, 2007

(54) Method for Delaying Accesses to Date and/or Instructions of a Two-Computer System, and Corresponding Delay Unit

(75) Inventors: Bernd Mueller, Gerlingen (DE); Werner Harter, Illingen (DE); Thomas Kottke, Ehningen (DE); Andreas Steininger, Wien (AT)

Correspondence Address: KENYON & KENYON LLP, ONE BROADWAY, NEW YORK, NY, 10004, US

(73) Assignee: ROBERT BOSCH GMBH, STUTTGART (DE)

(21) Appl. No.: 11/659,622

(22) PCT Filed: Aug. 3, 2005
(86) PCT No.: PCT/EP05/53791

§ 371 Date: Jul. 10, 2007

(30) Foreign Application Priority Data
Aug. 6, 2004 (DE) 10 2004 038 590.4

(51) Int. Cl. G06F 13/42

(52) U.S. Cl. 710/105

(57) ABSTRACT

A delay unit and a method for delaying accesses to data and/or instructions of a two-computer system having a first and a second computer, the first and the second computer operating with a time offset, and the delay unit being embodied in such a way that that time offset is compensated for in the two-computer system in the context of the accesses to data and/or instructions in at least one of the two computers, as well as a method and delay unit for delaying accesses to data and/or instructions of a computer system having error discovery mechanisms for error detection, wherein the time span between undelayed access to data and/or instructions and error detection is compensated for.

### FIELD OF THE INVENTION

The present invention proceeds from a method for delaying accesses to data and/or instructions of a two-computer system, and from a corresponding delay unit, in accordance with the features of the independent claims known from the existing art.

### BACKGROUND INFORMATION

In future applications, e.g. in particular in motor vehicles or in the industrial products sector, i.e. for example in machinery and in automation, there will be a steady increase in the number of microprocessor- or computer-based control and regulation systems for safety-critical applications. Two-computer or two-processor systems (“dual cores”) are common computer systems nowadays for safety-critical applications, in particular in vehicles, for example for antilock braking systems, electronic stability programs (ESP), by-wire systems such as drive-by-wire, steer-by-wire, or brake-by-wire, etc., or also in other networked systems. Powerful error mechanisms and error handling mechanisms are necessary in order to meet these stringent safety requirements in future applications, in particular in order to counteract transient errors that occur, for example, as computer system semiconductor structures are made smaller. It is relatively difficult in this context to protect the core itself, i.e. the processor. One solution to this, as mentioned, is the use of a two-computer or dual-core system for error detection.

A problem with such two-computer systems, however, is that the comparison of data, in particular of output data, for error detection purposes occurs only upon output or after output. In other words, the data are already being conveyed to an external sink, i.e. for example a component, such as a memory or other input/output element, connected via a data bus or an instruction bus, before the correctness of the data and/or instructions is ensured. This can then cause the execution of accesses, i.e. write operations and/or read operations, to erroneous data and/or instructions, especially in the context of errors in memory accesses. This problem can cause errors when restoring a specific system state, eliminating the consequences of an error, generating correct data after an error termination, making a system available again after a breakdown or, in the case of a circuit assemblage, returning to the original state (together referred to hereinafter as “recovery”), or can make such operations possible only with a great deal of effort. As a result of access in the form of write operations and/or read operations by at least one computer of the two-computer system, such errors can lead to errors in the entire system and in units connected thereto, an even more serious issue being that it is impossible to ascertain which data and/or instructions were erroneously modified.

It is therefore an object of the present invention to solve the aforesaid problem, in particular to detect and avoid access errors in a two-computer system, i.e. write operations and/or read operations, and thereby to prevent difficulties in particular with recovery of the two-computer system.

### SUMMARY OF THE INVENTION

The invention proceeds from a method and a delay unit for delaying accesses to data and/or instructions of a computer system having error discovery mechanisms, the delay unit being embodied in such a way that the time span between undelayed access to data and/or instructions and error detection is compensated for.

The invention furthermore proceeds from a method for delaying accesses, constituting write operations and/or read operations, to data and/or instructions of a two-computer system having a first and a second computer, the first and the second computer being operated with an, in particular predeterminable, time offset, and that time offset being compensated for in the two-computer system in the context of the accesses to data and/or instructions in at least one of the two computers, for which purpose a correspondingly configured delay unit according to the present invention is used.

Advantageously, a delay unit and a method are proposed in which an error detection operation is accomplished by comparison of the data and/or instructions of the first computer with the data and/or instructions of the second computer, the delay unit being configured in such a way, and a delay being accomplished in such a way, that the accesses, i.e. the write operations and/or read operations, with reference to the data and/or instructions of the two-processor system, in particular in the context of a computer, are delayed until the error detection operation is performed, with the result that it is possible to prevent erroneous data and/or instructions from experiencing an access, i.e. a write operation and/or a read operation.

The two computers of the two-computer system, or the two-computer system itself, are connected via a data bus to at least one first component, the delay unit being located on the data bus between at least one computer of the two-computer system and the at least one first component.

The two-computer system or the two computers can be connected via an instruction bus to at least one second component, the delay unit then advantageously being connected to or located on the instruction bus between at least one computer of the two-computer system and the at least one second component.

In a further embodiment with a mixed data/instruction bus, the two-computer system or the two computers of the two-computer system are connected to at least one third component, the delay unit then usefully being located on or inserted into the mixed data/instruction bus between at least one computer of the two-computer system and the at least one third component. The method is advantageously configured, and the delay unit embodied, in such a way that as accesses, both write operations and read operations, or only write operations, and in some circumstances only read operations, are delayed. By delaying the write operations of the at least one computer with regard to a first and/or second component having a corresponding linkage to the data bus and/or instruction bus, it is thus possible to prevent erroneous data output and/or instruction output, in particular erroneous writing into a memory, so that the consequences discussed above, in particular for the entire system, do not occur.

It is likewise possible simultaneously or exclusively to delay the read operations, so that error avoidance can also be accomplished in the context of the input of data and/or instructions with regard to at least one computer of the two-computer system, since on the one hand untested data and/or instructions are not accepted, or system errors cannot occur as a result of uncoordinated acceptance. At the same time, recovery problems can be avoided.

The delay unit advantageously contains a delay member, in particular having a predeterminable or adjustable delay, as well as a switchover module that is embodied in particular as a multiplex module and, usefully, as a secure multiplex module. The secure multiplex module is embodied in such a way that bit switchover elements are provided, and a switchover between delaying accesses and not delaying accesses is accomplished by way of a triggering signal, in particular a read/write signal or a signal derived therefrom, which is checked in a test unit, in particular a totally self-checking (TSC) checker, the triggering signal being conveyed first to the bit switchover elements and thereafter to the test unit.

The delay unit can advantageously be embodied in such a way that it itself acts, i.e. is implemented, in error-detecting fashion, in particular by way of the test unit, and outputs an error signal that is additionally useful, in particular is useful to an error handling system.

In order to avoid errors that are triggered, for example, by a write operation by the fact that erroneous data and/or instructions are being written, the delay unit is advantageously embodied in such a way that change signals are provided by which a write operation is changed into a read operation, so that erroneous writing of data and/or instructions is avoided.

A delay unit of this kind according to the present invention, and a method of this kind according to the present invention for delaying, can thus be used in identical fashion both for synchronous, i.e. in particular clock-synchronized, two-processor systems or two-computer systems and for non-clock-synchronized, i.e. non-synchronous, ones, and also in other computers having error discovery mechanisms in which the error can be detected only during or after output of the data, and as a result the error signal is not available in timely fashion for error avoidance in synchrony with output of the data. The aforesaid errors in the context of accesses with regard to data and/or instructions can thereby be avoided; in particular, it is possible to ensure that the data and/or instructions with regard to a memory access cannot be destroyed by errors in the two-processor or two-computer system. In addition, the aforementioned difficulties in terms of recovery of the two-computer system can be avoided.

### BRIEF DESCRIPTION OF THE DRAWINGS

The invention will be explained in more detail below with reference to the Figures depicted in the drawings.

FIG. 1 shows a two-computer system or two-processor system having a delay unit according to the present invention.

FIG. 2 depicts a first embodiment of a delay unit according to the present invention.

FIG. 3 depicts a second embodiment of a delay unit according to the present invention.

FIG. 4 shows a multiplex module, in particular a secure multiplexer, of a delay unit according to the present invention.

The invention will be explained in further detail below with reference to the exemplary embodiments.

### DETAILED DESCRIPTION OF THE DRAWINGS

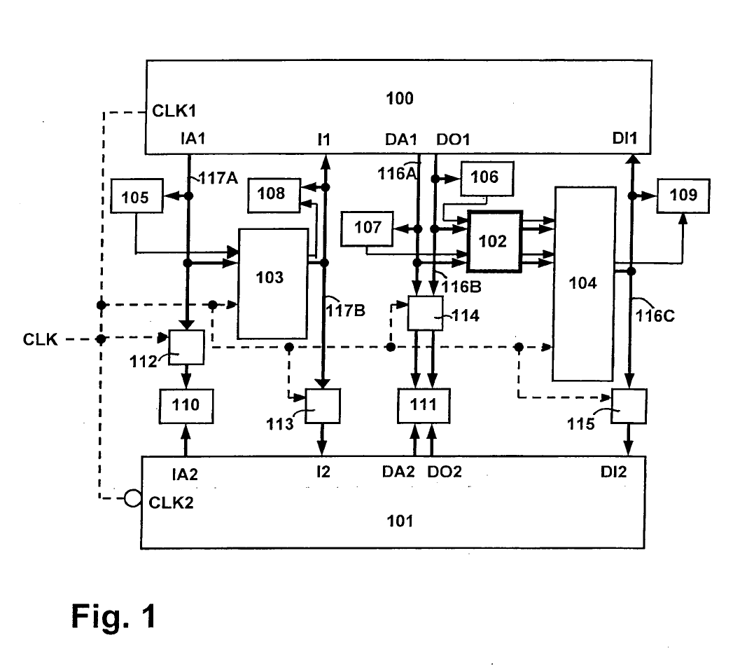

FIG. 1 shows a two-computer system having a first computer 100, in particular a master computer, and a second computer 101, in particular a slave computer. The entire system is operated with a predeterminable clock pulse or in predeterminable clock cycles CLK. The clock pulse is conveyed via clock input CLK1 of computer 100 thereto, and via clock input CLK2 of computer 101 thereto. This two-computer system moreover, by way of example, contains a special feature for error detection, in which first computer 100 and second computer 101 operate with a time offset, in particular with a predeterminable time offset or a predeterminable clock pulse offset. Any desired time may be predetermined for a time offset, and also any desired clock pulse with regard to an offset of the clock cycles. This can be a whole-number offset of the clock cycle but also, as in fact depicted in this example, can be e.g. an offset of 1.5 clock cycles, in which case first computer 100 works or is operated 1.5 clock cycles before second computer 101. With this offset it is possible to prevent so-called common-mode failures from disrupting the computers or processors, i.e. the cores of the dual-core system, in identical fashion, and thus remaining undetected. In other words, as a result of the offset, such common-mode failures affect the computers at different times during program execution and hence cause different effects with respect to the two computers, with the result that errors become detectable. Identical error effects with no clock offset would in some circumstances not be detectable in a comparison; this is thereby prevented. Offset modules 112 to 115 are implemented in order to implement this offset with regard to time or clock pulse, in this case in particular 1.5 clock cycles, in the two-computer system.

In order to detect the aforesaid common-mode failures, this system is designed, for example, to operate with a predetermined time offset or clock cycle offset, in particular 1.5 clock cycles in this case; i.e. while the one computer, e.g. computer 100, directly addresses the components, in particular external components 103 and 104, second computer 101 works with a delay of exactly 1.5 clock cycles with respect thereto. In order to generate the desired delay of one and a half cycles, i.e. 1.5 clock cycles, in this case, computer 101 is supplied with the inverted clock pulse at clock input CLK2. As a result, however, the aforesaid connections of the computer, i.e. its data and instructions via the buses, must also be delayed by an amount equal to the aforesaid clock cycles, i.e. in this case in particular 1.5 clock cycles, offset modules or delay modules 112 to 115 being provided, as just stated, for this purpose. In addition to the two computers of processors 100 and 101, components 103 and 104 are provided which are in communication with the two computers 100 and 101 via buses 116 made up of bus lines 116A and 116B and 116C, as well as 117 made up of bus lines 117A and 117B. 117 is an instruction bus, in which 117A is designated an instruction address bus and 117B the partial instruction (data) bus. Address bus 117A is connected via an instruction address 1 terminal IA1 to computer 100, and via an instruction address 2 terminal IA2 to computer 101. The instructions themselves are transferred via partial instruction bus 117B, which is connected via an instruction 1 terminal I1 to computer 100 and via an instruction 2 terminal I2 to computer 101. Interposed in this instruction bus 117 made up of 117A and 117B is a component 103, e.g. an instruction memory, in particular a secure instruction memory or the like. This component as well, in particular constituting an instruction memory, is operated in this example with clock pulse CLK. Also depicted, as 116, is a data bus that contains a data address bus or data address line 116A and a data bus or data line 116B. 116A, i.e. the data address line, is connected via a data address 1 terminal DA1 to computer 100, and via a data address 2 terminal DA2 to computer 101. The data bus or data line 116B is likewise connected via a data out 1 terminal DO1 and a data out 2 terminal DO2 to computers 100 and 101 respectively. Also belonging to data bus 116 is data bus line 116C, which is connected via a data in 1 terminal DI1 and a data in 2 terminal DI2 to computer 100 and computer 101 respectively. Interposed in this data bus 116 made up of lines 116A, 116B, and 116C is a component 104, for example a data memory, in particular a secure data memory or the like. This component 104 is also, in this example, supplied with clock pulse CLK.

Components 103 and 104 are representative of any desired components that are connected via a data bus and/or instruction bus to the computers of the two-computer system and, in accordance with the accesses via data and/or instructions of the two-computer system with regard to write operations and/or read operations, can receive or deliver erroneous data and/or instructions. Error identification generators 105, 106 and 107 are provided for error avoidance, and generate an error identifier such as, for example, a parity bit or also another error code such as, for example, an error correction code (ECC) or the like. The corresponding error identifier check devices 108 and 109 are then also provided for checking the respective error identifier, i.e. for example the parity bit or another error code such as an ECC.

Comparison of the data and/or instructions in terms of the redundant embodiment in the two-computer system is accomplished in comparators 110 and 111 as depicted in FIG. 1. If, however, a time offset, in particular a clock or clock cycle offset, exists between computers 100 and 101—brought about either by a non-synchronous two-processor system, or in the case of a synchronous two-processor system by synchronization errors, or also, as in this specific example, by a time offset or clock cycle offset (in this case, in particular, of 1.5 clock cycles) that is desired for error detection—then during this time offset or clock pulse offset a computer, in particular computer 100 in this case, can write or read erroneous data and/or instructions to or from components, in particular external components such as, in this example, memories 103 or 104, but also with regard to other subscribers or actuators or sensors. It can therefore also, as a result of this time offset, erroneously perform a write access instead of a stipulated read access. These scenarios of course lead to errors in the entire system, in particular with no clear capability for indicating which data and/or instructions have just been erroneously modified, thus also causing recovery problems.

In order to solve these problems a delay unit 102 is inserted, as depicted, into the lines of the data bus and/or into the instruction bus. For reasons of clarity, only insertion into the data bus is depicted; this is of course equally possible and conceivable with regard to the instruction bus. This delay unit 102 delays the accesses, in this case in particular the memory accesses, in such a way that any possible time offset or clock offset is compensated for, in particular, in the case of error detection e.g. by way of comparators 110 and 111, for example at least until the error signal has been generated in the two-computer system, i.e. until error detection in the two-computer system has been carried out. A number of variants can be implemented: delaying the write and read operations; delaying only the write operations; or also, although not preferred, delaying the read operations. By way of a change signal, in particular the error signal, a delayed write operation can be converted into a read operation in order to suppress erroneous writing.

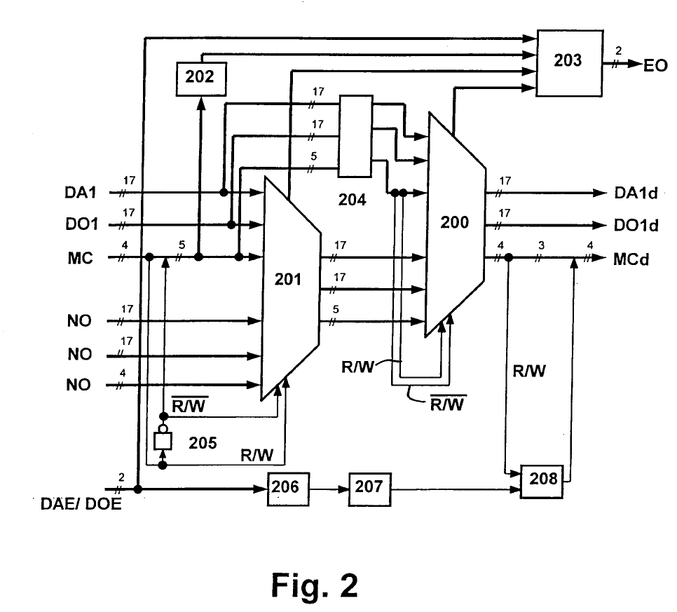

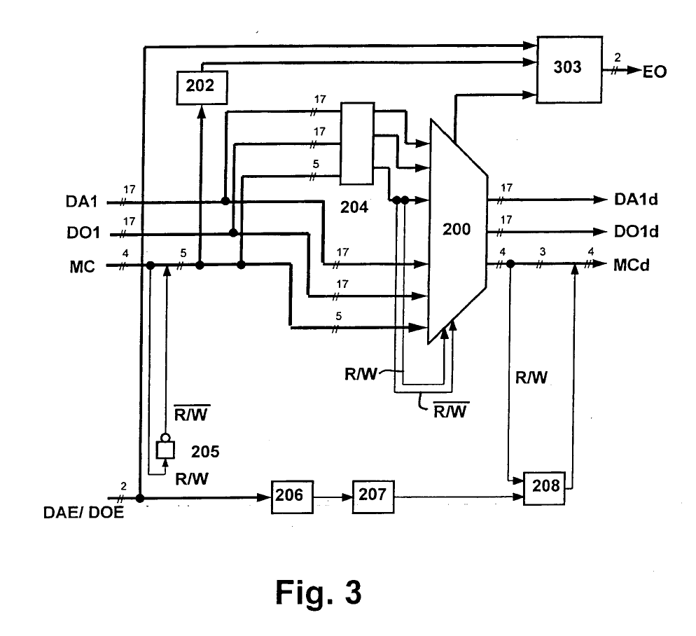

Different ways of implementing delay unit 102 are depicted in FIGS. 2 and 3. The purpose of delay unit 102 is to delay accesses, in the context of the aforesaid time offset or clock cycle offset, in order to compensate for them, in particular in order to¹ write operations by computer 100 to a component, in particular an external component, until checking has occurred, and thereby to achieve correctness with regard to the corresponding data and/or instructions or the respective addresses. The delay unit can also be implemented in such a way that it detects errors in itself, and signals this to the outside by way of an error signal EO; this is explained again in more detail with reference to FIGS. 2 and 3.

FIG. 2 shows a delay unit having two switchover modules 201 and 200 (in particular multiplex modules), a delay member 204, and a test device 203, in particular a TSC checker. The delay unit is made up of two branches: a read branch that corresponds to the lower input path of multiplexer 200 (the lower three arrows) including multiplexer 201, and a write branch, i.e. the upper input path of multiplexer 200 (the upper three arrows). In other words, the delay unit, especially when it is intended to delay only write operations, is made up of two paths between which it is possible to change over by way of a switchover device, in particular a multiplexer 200. In the one path, data and/or instructions (in this case data from data out 1 DO1), the corresponding addresses (in this case data address 1 DA1), and additionally in this case, in particular, memory control signals MC, pass through in undelayed fashion; in the other branch they are delayed by delay member 204. The switchover between the two paths is accomplished by way of a switchover signal, in particular read/write signal R/W or its inversion, i.e. a signal Invert R/W derived therefrom (=RW=R/W with a dash over it, in FIGS. 2 to 4).

In the write branch, i.e. the branch having delay member 204, for example, a delay of two clock cycles takes place in the context of a predetermined delay of 1.5 clock cycles as described previously, and is therefore longer than the required minimum of 1.5 clock cycles; this allows a memory to be operated using the same clock input CLK. In other words, the delay is at least as long as the stipulated time offset (in this case 1.5 clock cycles), but can also, as in this example, be longer. In order to create consistency, the pertinent address and control signals are identically delayed. As stated, this is not only possible for the data bus (as just presented by way of example for the data bus using DA1 and DO1), but also conceivable for the instruction bus. The presentation could thus easily be transferred to an instruction bus for IA1.

The numbers of bits on the individual connections in FIGS. 2 and 3 are selected by way of example, i.e. this example proposes a 16-bit system plus one parity bit (16 bits+1 parity bit=17 bits). Transferring this to different bit widths such as 8, 32, 64 bits plus a parity bit, or wider error identifiers, is easily possible, and conceivable according to the present invention. The selection of 4 bits for the memory control signal MC is also an example. The number of 5 bits, by way of the additional incoupled R/W-Invert bit then yielding 5 bits (4 bits+1 R/W invert=5 bits), must also be regarded as an example. In the lower input branch of switchover module 200 (the lower three arrows and switchover module 201 included here), the delay is bypassed by switchover device 200 under the control of a switchover signal (in particular using read/write signal R/W or the Invert R/W derived therefrom). When R/W (read/write signal) is used, it is converted by inverting member 205 to the inverted read/write signal. Second switchover module 200, in particular the second multiplexer that recombines the data and/or instructions (in this case, by way of example, the data), is also triggered by this signal, in particular the read/write signal R/W and the one inverted from it. As described below, it is advantageous in this context to take the signal from the delayed path, i.e. behind delay member 204.

It is useful, therefore, to select the delayed read/write signal R/W or the Invert-R/W (= R̅/̅W̅) inverted therefrom, because otherwise, in some circumstances, an access, in particular a write access, would be initiated without achieving the desired delay of, in the present example, two clock cycles before the other associated signals are present. This would result, in some circumstances, in problems with a switchover between read and write accesses. For example, if a read access (read operation) occurs directly after a write access (write operation), the delayed write access and the read access directly subsequent to it would need to be executed in parallel. In other words, there should not be a spacing of exactly two clock pulses between a write operation and a write operation subsequent thereto, and it is easier to implement if a minimum spacing of, in this case, two clock cycles is effected between a write operation and a read operation subsequent thereto. In the case of a write operation, a gap equal to the duration of the write operation occurs at the output of switchover module 200. During this gap, switchover module 200, i.e. the multiplexer, would activate the read branch, i.e. the three lower inputs of multiplexer 200; the undelayed data or addresses and control information of this branch still belong to the write operation. To prevent this information, i.e. the previous operation, from getting onto the bus, switchover device 201 is provided, which in this case supplies noncritical constants (e.g. the “no operation” NO as depicted here in FIG. 2) to the lower input of multiplexer 200 while this waiting time exists, until multiplexer 200 changes over, as need be, to the three upper input pathways, i.e. the delayed one, and performs the current write operation.

In order to secure the interfaces in this case with respect to other components, the data address 1 DA1, data out 1 DO1, and memory control MC signals are each secured, in this example, by a single parity bit. This parity is secured by check units 109 and 108 for the instruction bus; although this is not depicted in FIG. 1, the memory control signal MC is secured by an additional memory checker 202. The parity bit of this signal MC is delayed by delay member 204 in the same way as the other signals. Because the signals of each signal type DA1, DO1, and MC are conveyed independently in the delay unit, this single parity bit allows sufficient protection against individual errors. In the case of multiple error detection or security, and correction of multiple errors, more-powerful error identifiers can be used, as already mentioned.

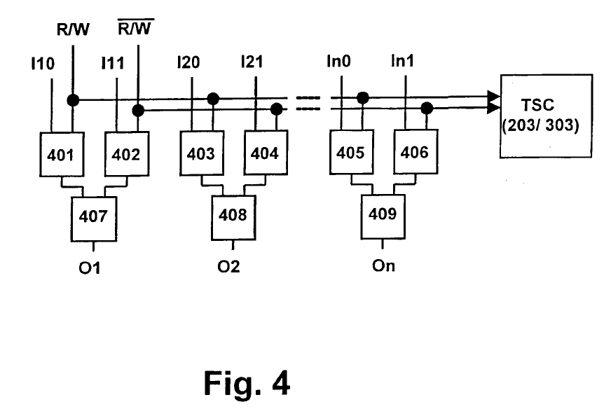

Because the switchover signal or change signal, i.e. in this case read/write signal R/W, plays a special role in controlling the switchover units, in a particular concrete embodiment it is to be secured further. This is to be achieved by way of a dual rail code directly upon input into the delay unit; this is explained once again in more detail with reference to FIG. 4.

An additional function can be implemented via the DAE/DOE path 206, 207, and 208. In this fashion, protection of write operations in the event of an error in standard components, for example a fail-safe memory, or similarly in the switchover of a write operation into a read operation, can be achieved. Error signal DAE/DOE of the dual core is present as a dual rail code. This is converted into a single rail signal, before a time offset exists between them. This takes place in a comparison module 206 that can be embodied, in particular, as an XOR module. XOR member 206 simultaneously turns the multiple signal into a single signal. Optionally, a time delay of 0.5 clock cycles is then added in a delay member 207 in order to achieve a chronological alignment of the resulting error signal with the corresponding data word in the delay unit. The reason for this is that in our example, the delay unit is delayed by two clock cycles in accordance with delay member 204. If an AND gate, for example, is then used as block 208, read/write signal R/W can be masked in order to block a write access, as depicted in connection with the wiring of block 208.

This DAE/DOE input, i.e. the error signal from the computers, can, like the parity bit of memory controller MC from 202 and the respective switchover or change signal of switchover devices 201 and 202, i.e. in particular read/write signal R/W as well as the inverted read/write signal (Invert R/W) derived therefrom, be conveyed to test module 203 (embodied in particular as a TSC checker), resulting in an error signal EO (Error Out) that is useful for further error handling. The use of the read/write signals R/W and R/W for switchover in the multiplexer, and their checking, is explained in more detail in FIG. 4, as already mentioned.

In the delay unit as shown in FIG. 2, there occurs at the output (depending on embodiment) an either undelayed or delayed data address signal DA1d; an either undelayed data signal or data output signal DO1d, as a function of a read operation or write operation; and, in this specific example when a memory module is used as a component, in particular an external component, a memory control signal MCd (Memory Control delayed), which likewise is either undelayed or delayed.

FIG. 3 shows once again, in a second embodiment, a delay unit in which the delay unit, as depicted, can also be embodied from only one switchover module or multiplexer 200 and two branches. Only second multiplexer 200 from FIG. 2 is used here, so that inputs DA1, DO1, and MC are conveyed directly to it. The same inputs are, as previously, already delayed via a delay member 204, and are likewise conveyed to multiplexer 200. The data (i.e. in this case data address DA1, data DO1, and memory control MC) proceed simultaneously in both branches, write operations in the undelayed path being converted into read operations. This change or switchover of write operations into read operations can also be brought about by read/write signals R/W or the R/W inverted derived therefrom.

The second embodiment is otherwise configured comparably to the first embodiment, except for the fact that first multiplexer 201 has been omitted; the designations and functions (if present) are therefore also identical. One exception is the test unit, since it has fewer signals conveyed to it because of the absence of multiplexer 201, and therefore can be constructed slightly differently and is therefore here designated 303. It nevertheless outputs, in the same fashion, the useful error signal EO which is reusable in the context of error handling.

Especially in the case of a von Neumann architecture in which the components are appended to a common bus, it is advantageous if only the write operation is delayed. Usefully, the instruction memory accesses and the read operations occur without delay in the context of the von Neumann architecture.

In the delay unit, secure multiplexers according to FIG. 4 can be used as switchover modules or multiplexers. The data are secured by way of an error detection code, in this example a parity bit, and the triggering signals (i.e. switchover or change signals, in this case in particular read/write signal R/W and the inverted read/write signal R̅/̅W̅ derived therefrom) are likewise secured, in this example using dual rail logic. In other words, the R/W and inverted signal are first conveyed to the secure multiplexer and from there to the test unit (TSC checker) 203 or 303. Under these conditions, an error that relates to one rail of the read/write signal is detected by test unit TSC 203 or 303, whereas a single error in the multiplex circuit will affect a single output bit and can thus be ascertained by way of the parity check. In other words, as previously discussed, the data and/or instructions are changed over as in a standard multiplexer, the parity bit or a different error identifier additionally being switched over. The triggering signals, i.e. switchover or change signals R/W and inverted R/W, are first sent to all the switchover elements for the individual bits—depicted here in modules 401 to 406, in particular, as AND gates—to which the respective inputs I10, I11, I20, I21 to In0, In1 are likewise conveyed. The modules and their output signals from 401 to 406 are then grouped together respectively in modules 407 to 409 as depicted in FIG. 4. For that purpose, modules 407 to 409 are embodied in particular as OR gates, yielding multiplex module outputs O1, O2, to On. The structure depicted in FIG. 4 is only a portion of the overall structure of a multiplex module according to FIGS. 2 and 3, with the bit widths of 17 bits and 5 bits per signal pathway depicted therein by way of example. In other words, both multiplex modules 201 and 200 in accordance with FIGS. 2 and 3 are advantageously embodied in the form of FIG. 4 in order to make an erroneously changed-over data pathway detectable as already described, and to simplify error identification. It would not be possible to ascertain such errors by mere parity checking, since the data from the incorrect signal pathway would also have the correct parity provided no bit flips are present.

This security package is completed by securing the interface to a component, in particular to an external component corresponding to 103 and 104 of FIG. 1, by the fact that, as already depicted in FIG. 1, error identification units for generating error identifier 105-107, and error checking units for checking the error identifier, for example 108 and 109—constituted in particular as parity bit checkers and parity bit generators—are provided. The error signals created in this context can then also be used in the delay module as DAE/DOE (data address error/data out error) signals according to FIG. 2 and FIG. 3, as described.

With the use of a secure multiplexer, in which the triggering signals or switchover or change signals R/W and inverted R/W are first sent to all the switchover elements for the individual bits and only thereafter checked in the TSC checker, errors in the triggering signals can thus be detected by testing them; and if only one bit is erroneously changed over, this is detected by way of the data coding of the data that are to be changed over.

The invention thus makes possible, with relatively simple means, a considerable increase in security in the context of a two-computer system.

1-19. (canceled)

20. A delay unit for delaying access to at least one of data and instructions of a computer system having an error discovery mechanism, comprising:
an arrangement for compensating for a time span between undelayed access to an error detection and the at least one of data and instructions.

21. A delay unit for delaying access to at least one of data and instructions of a two-computer system having a first computer and a second computer, the first computer and the second computer operating with a time offset, the delay unit comprising: an arrangement for compensating for the time offset in the two-computer system in the context of accesses to the at least one of data and instructions in at least one of the two computers.

22. The delay unit as recited in claim 21, further comprising:
an arrangement for performing, by comparison of the at least one of data and instructions of the first computer with the at least one of data and instructions of the second computer, an error detection operation; and an arrangement for delaying the accesses until the error detection operation is performed.

23. The delay unit as recited in claim 21, wherein:
the two-computer system is connected to at least one first component via a data bus, and
the delay unit is located on the data bus between the first computer and the at least one first component.

24. The delay unit as recited in claim 23, wherein:
the two-computer system is connected via an instruction bus to at least one second component, and
the delay unit is located on the instruction bus between the first computer of the, two-computer system and the at least one second component.

25. The delay unit as recited in claim 21, wherein:
the two-computer system is connected via a mixed data/instruction bus to at least one first component, and
the delay unit is located on the mixed data/instruction bus between the first computer and the at least one first component.

26. The delay unit as recited in claim 20, wherein:
as accesses, write operations and read operations are delayed.

27. The delay unit as recited in claim 20, wherein:
as accesses, only write operations are delayed.

28. The delay unit as recited in claim 20, wherein:
as accesses, only read operations are delayed.

29. The delay unit as recited in claim 20, further comprising:
a delay member; and
a switchover module.

30. The delay unit as recited in claim 20, wherein the delay unit performs a switchover between delay of accesses and non-delay of accesses.

31. The delay unit as recited in claim 30, wherein the switchover is initiated by way of one of a read/write signal and a signal derived therefrom.

32. The delay unit as recited in claim 20, wherein the delay unit itself is error-detecting.

33. The delay unit as recited in claim 29, wherein the switchover module includes a secure multiplex module.

34. The delay unit as recited in claim 33, wherein:
the secure multiplex module is embodied in such a way that a bit switchover element is provided, and
a switchover is accomplished by way of a triggering signal that is checked in a test unit, the triggering signal being conveyed first to the bit switchover element and thereafter to the test unit.

35. The delay unit as recited in claim 20, wherein:
the access is embodied as one of a write operation and a read operation, and change signals are provided by which the write operation is changed into the read operation.

36. A two-computer system, comprising:
a first computer;
a second computer; and
a delay unit that includes an arrangement for compensating for a time offset in the two-computer system in the context of accesses to at least one of data and instructions in at least one of the two computers.

37. A method for delaying access to at least one of data and instructions of a two-computer system having a first computer and a second computer, the first computer and the second computer operating with a time offset, the method comprising:
compensating for the time offset in the two-computer system in the context of accesses to the at least one of data and instructions in at least one of the two computers.

38. A method for delaying access to at least one of data and instructions of a computer system having an error discovery mechanism, comprising:
compensating for a time span between undelayed access to an error detection and the at least one of data and instructions.
